(19) United States
(12) Patent Application Publication
(10) Pub. No.: US 2018/0018607 A1
(43) Pub. Date: Jan. 18, 2018

(54) SKILL TRANSFER FACILITATING APPARATUS, SKILL TRANSFER FACILITATING METHOD, AND COMPUTER-READABLE RECORDING MEDIUM

(71) Applicants: NEC Solution Innovators, Ltd., Tokyo (JP); KEIO UNIVERSITY, Tokyo (JP)

(72) Inventors: Dai KUSUI, Tokyo (JP); Toshiyuki KAMIYA, Tokyo (JP); Atsushi SHINJO, Kanagawa (JP); Yutaro ONO, Kanagawa (JP); Masahiro KUDO, Kanagawa (JP)

(73) Assignees: NEC Solution Innovators, Ltd., Tokyo (JP); KEIO UNIVERSITY, Tokyo (JP)

(21) Appl. No.: 15/545,843

(22) PCT Filed: Jan. 6, 2016
(86) PCT No.: PCT/JP2016/050231

§ 371 Date: Jul. 24, 2017

(30) Foreign Application Priority Data
Jan. 28, 2015 (JP) 2015-014259

(51) Int. Cl. G06Q 10/06; G06N 5/02; G06Q 50/02

(52) U.S. Cl. CPC G06Q 10/063112; G06Q 50/02; G06N 5/025; G06Q 10/06398

(57) ABSTRACT

A skill transfer facilitating apparatus 10 is an apparatus for facilitating skill transfer, and includes a data accumulation unit 11 that accumulates data regarding tasks that are executed using skills that are to be transferred; and a rule creation unit 12 that extracts, from the data that is accumulated, task names, task execution results, and task reasons as information, executes, for each combination of a task name and a task execution result thus extracted, statistical processing with respect to each corresponding task reason, and then creates, for each task, a rule that serves as a condition for executing the task or a condition for not executing the task, based on the result of statistical processing.

### TECHNICAL FIELD

The present invention relates to a skill transfer facilitating apparatus and a skill transfer facilitating method that facilitate the transfer of various kinds of skills, and to a computer-readable recording medium on which a program for realizing them is recorded.

### BACKGROUND ART

In recent years, in the field of agriculture, it has become increasingly important to establish a brand for each production area. Therefore, the entire production area needs to be able to continuously supply a certain amount of high-quality farm products to markets, and for this purpose, it is necessary to improve the quality of farm products that are produced by inexperienced farmers, so as to be as good as the quality of farm products that are produced by experienced farmers.

It is believed that the quality of farm products largely depends on the skills of the farmers. Therefore, in order to establish a brand for each production area, it is important to make it as easy as possible to transfer the skills that experienced farmers have to farmers that belong to the same production area. If the transfer of skills from experienced farmers is easier, it may also be possible to solve the problem of a shortage of successors in the field of agriculture.

Hereinafter, skill transfer in the field of agriculture will be described based on the case of growing oranges, for example. When growing oranges, it is necessary to execute farming tasks such as pruning, watering, and fertilizing at appropriate times, at appropriate locations, and for the appropriate amounts. However, the timing, the location, and the amount are determined based on the experience and intuition of the farmer. That is to say, skills are the ability to determine what farming task should be executed, and when, at what location, and to what extent the farming task should be executed.

In order to transfer skills, an inexperienced farmer needs to take an experienced farmer as his/her teacher and learn skills from the teacher. However, there is a problem in that such skill transfer takes too much time. In view of this problem, Patent Document 1, for example, proposes a system that facilitates skill transfer regarding farming tasks.

Specifically, according to the system disclosed in Patent Document 1, farming tasks that a user needs to execute are registered as rules, which are classified by conditions such as the state of the crop and the state of the environment. Upon the user inputting information regarding the state of the crop, the state of the environment, and so on, the system compares the input conditions with the rules, selects the most suitable farming task, and presents it to the user. In this way, the system disclosed in Patent Document 1 makes it easier to transfer skills regarding farming tasks to inexperienced users, and the system is believed to be able to solve the problem of a shortage of successors.

### CITATION LIST

### Patent Document

Patent Document 1: JP 2012-155432A

### Disclosure of the Invention

### Problems to be Solved by the Invention

When the system disclosed in the above-described Patent Document 1 is to be used, the degree of completion of rules that have been registered in advance is important. In other words, if the degree of completion of the rules is low, skill transfer cannot be appropriately facilitated, and it becomes difficult for inexperienced farmers to produce farm products that have a certain degree of quality.

However, in the system disclosed in the above-described Patent Document 1, the rules are created in advance by farmers, experts, or the like, based on their past experience and so on, and the degree of completion of the rules depends on the farmers or experts who create the rules. Therefore, there is demand for an approach to create rules with a high degree of completion.

The present invention aims to provide a skill transfer facilitating apparatus, a skill transfer facilitating method, and a computer-readable recording medium that can improve the degree of completion of rules that are used in skill transfer.

### Means for Solving the Problems

To achieve the above-described aim, one aspect of the present invention provides a skill transfer facilitating apparatus for facilitating skill transfer, including:

a data accumulation unit that accumulates data regarding tasks that are executed using skills that are to be transferred; and

a rule creation unit that extracts, from the data that is accumulated, task names, task execution results, and task reasons as information, executes, for each combination of a task name and a task execution result thus extracted, statistical processing with respect to each corresponding task reason, and then creates, for each task, a rule that serves as a condition for executing the task or a rule that serves as a condition for not executing the task, based on the result of statistical processing.

Also, to achieve the above-described aim, one aspect of the present invention provides a skill transfer facilitating method for facilitating skill transfer, including:

(a) a step of accumulating data regarding tasks that are executed using skills that are to be transferred; and

(b) a step of extracting, from the data that is accumulated, task names, task execution results, and task reasons as information, executing, for each combination of a task name and a task execution result thus extracted, statistical processing with respect to each corresponding task reason, and then creating, for each task, a rule that serves as a condition for executing the task or a rule that serves as a condition for not executing the task, based on the result of statistical processing.

Furthermore, to achieve the above-described aim, one aspect of the present invention provides a computer-readable recording medium on which a program for facilitating skill transfer using a computer is recorded, the program including an instruction to cause the computer to execute:

(a) a step of accumulating data regarding tasks that are executed using skills that are to be transferred; and

(b) a step of extracting, from the data that is accumulated, task names, task execution results, and task reasons as information, executing, for each combination of a task name and a task execution result thus extracted, statistical processing with respect to each corresponding task reason, and then creating, for each task, a rule that serves as a condition for executing the task or a rule that serves as a condition for not executing the task, based on the result of statistical processing.

### Effects of the Invention

As described above, the present invention can improve the degree of completion of rules that are used in skill transfer.

### BRIEF DESCRIPTION OF THE DRAWINGS

FIG. 1 is a block diagram showing a schematic configuration of a skill transfer facilitating apparatus according to an embodiment of the present invention.

FIG. 2 is a block diagram showing a specific configuration of a skill transfer facilitating apparatus according to the embodiment of the present invention.

FIG. 3 is a diagram showing an example of data that is accumulated according to the embodiment of the present invention.

FIG. 4 is a flowchart showing operations of a skill transfer facilitating apparatus according to the embodiment of the present invention.

FIG. 5 is a diagram showing an example of results of statistical processing according to the embodiment of the present invention.

FIG. 6 is a diagram showing an example of a database that is built in the embodiment of the present invention.

FIG. 7 is a block diagram showing an example of a computer that realizes the skill transfer facilitating apparatus according to the embodiment of the present invention.

### DESCRIPTION OF EMBODIMENT

### Embodiment

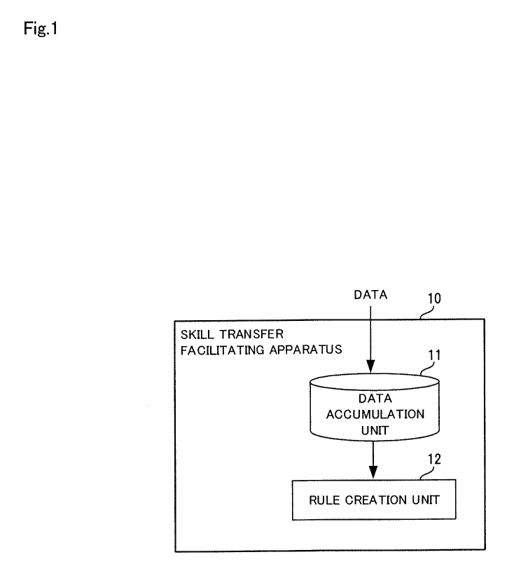

The following describes a skill transfer facilitating apparatus, a skill transfer facilitating method, and a program according to an embodiment of the present invention with reference to FIGS. 1 to 7.

### Configuration of Apparatus

First, a schematic configuration of a skill transfer facilitating apparatus according to the present embodiment will be described with reference to FIG. 1. FIG. 1 is a block diagram showing a schematic configuration of the skill transfer facilitating apparatus according to the embodiment of the present invention.

A skill transfer facilitating apparatus 10 according to the present embodiment shown in FIG. 1 is an apparatus for facilitating skill transfer. As shown in FIG. 1, the skill transfer facilitating apparatus 10 includes a data accumulation unit 11 and a rule creation unit 12.

The data accumulation unit 11 accumulates data regarding tasks that are to be executed using skills that are to be transferred. In the present embodiment data regarding tasks (hereinafter denoted as “task data”) is externally input. The task data includes at least information such as a task name, a task execution result that indicates whether or not the task was actually executed, and task reasons. Note that a task reason indicates why a task was executed if a task was actually executed, and indicates why a task was not executed if a task was not executed.

The rule creation unit 12 first extracts task names, task execution results, and task reasons as information from data that is accumulated in the data accumulation unit 11. Furthermore, the rule creation unit 12 executes, for each combination of a task name and a task execution result thus extracted, statistical processing on the corresponding task reasons. Then, based on the results of statistical processing, the rule creation unit 12 creates, for each task, rules that serve as conditions for executing the task or conditions for not executing the task.

In this way, in the present embodiment, statistical processing is executed with respect to the reason why a task was executed and the reason why a task was not executed, and thus reasons that are supported by many people who have input the data, i.e. many people who executed the tasks, are specified. Rule for skill transfer are then created based on the specified reasons, and therefore it is possible to improve the degree of completion of the rules that are used for skill transfer. Also, consequently, a person to whom skills are to be transferred is able to appropriately execute tasks.

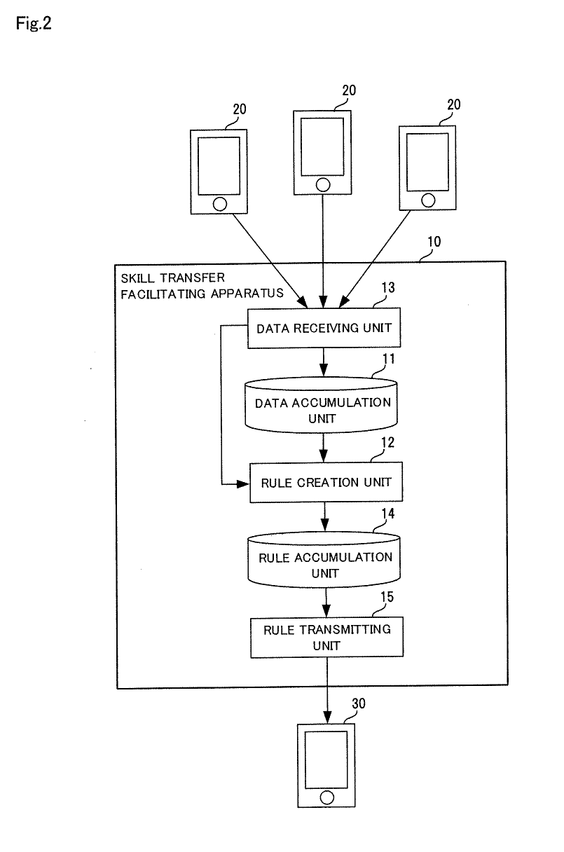

Next, a specific configuration of the skill transfer facilitating apparatus 10 according to the present embodiment will be described with reference to FIG. 2. FIG. 2 is a block diagram showing a specific configuration of the skill transfer facilitating apparatus according to the embodiment of the present invention.

As shown in FIG. 2, in the present embodiment, the skill transfer facilitating apparatus 10 is connected to terminals 20 for workers who input task data, and a terminal 30 for a user who utilizes the rules, via a network (not shown in FIG. 2).

In the present embodiment, the skills that are to be transferred are skills for farming, and the following description is based on the case of growing oranges, for example. Note that, in the present embodiment, the skills that are to be transferred may be skills other than those for growing oranges in the field of agriculture, such as growing apples, growing strawberries, or growing rice. Furthermore, skills that are to be transferred may be skills in the field of an industry other than agriculture, such as traditional craftwork, fisheries, forestry, or nursing care.

In the present embodiment, a worker inputs a task name, a task execution result, and a task reason to a terminal 20 while executing a task that is required for growing oranges, such as watering, fertilizing, or harvesting. The terminal 20 creates task data based on the input information, and transmits the task data thus created to the skill transfer facilitating apparatus 10. At this time, the worker can also attach, to the task data, an image that shows the state of a task.

Also, as shown in FIG. 2, in the present embodiment, the skill transfer facilitating apparatus 10 includes a data receiving unit 13, a rule accumulation unit 14, and a rule transmitting unit 15, in addition to the data accumulation unit 11 and the rule creation unit 12.

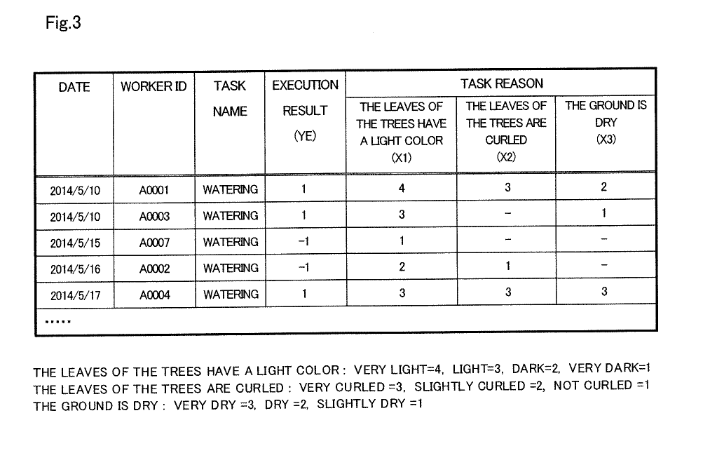

The data receiving unit 13 receives task data that has been transmitted from the terminals 20, outputs the received task data to the data accumulation unit 11, and accumulates the task data therein. Here, a specific example of task data in the present embodiment will be described with reference to FIG. 3. FIG. 3 is a diagram showing an example of data that is accumulated, in the embodiment of the present invention.

In the example shown in FIG. 3, the data accumulation unit 11 stores, for each piece of task data, a task date, a worker ID, a task name, a task execution result, task reasons, and an image ID. Among these items, the worker ID is an identifier that identifies the worker. The image ID is an ID of an image that the worker has attached, and the image ID is empty if no image is attached. The task execution result is represented as “1” if the task was executed, and is represented as “−1” if the task was not executed.

Although the example in FIG. 3 shows task data in the case where the task name is “watering”, the task name is not particularly limited in the present embodiment. Examples of task names include names of various tasks such as pruning, fertilizing, and weeding.

Furthermore, in the example shown in FIG. 3, task reasons are represented by using a numerical value to express, for each predetermined item, the degree of the item. For example, an item “the color of the leaves of the trees” is represented as “4” if the color is very light, “3” when the color is light, “2” when the color is dark, and “1” when the color is very dark. Therefore, in the present embodiment, the worker can input “task reasons” by simply inputting a value to each of the items that are displayed on the screen of the terminal 20. A mechanism for converting an expression of a degree to a numerical value may also be provided. For example, if “very light” is selected as the value of the item “the color of the leaves of the trees” on the screen of the terminal 20, the value may be converted into numerical value “1”. Note that the task date, the worker ID, and the image ID out of the above-described information may be omitted.

In the present embodiment, the rule creation unit 12 first executes, as statistical processing, multiple regression analysis for each combination of a task name and a task execution result, and for each of the corresponding task reasons, to calculate a correlation coefficient of the corresponding task reason. Upon multiple regression analysis being executed, the rule creation unit 12 extracts task reasons whose correlation coefficients are greater than or equal to a threshold value, and creates rules using the task reasons thus extracted. The rules created in this way show “what point should satisfy what condition in order for a task to be executed (or not to be executed)”. Note that a specific example of multiple regression analysis will be described later. In the present embodiment, an approach other than multiple regression analysis may be used as statistical processing.

The rule creation unit 12 also outputs the created rules to the rule accumulation unit 14, and accumulates the rules therein. Furthermore, if the task data that is accumulated in the data accumulation unit 11 includes images that relate to tasks, the rule creation unit 12 may add the corresponding images to the created rules.

In the present embodiment, as shown in FIG. 3, the data accumulation unit 11 accumulates worker IDs. Therefore, the rule creation unit 12 can extract, from the task data, the task name, the task execution result, and the task reason for each worker, based on the worker IDs, and can also create rules for each worker by executing statistical processing.

Furthermore, although not shown in the example in FIG. 3, the data accumulation unit 11 can also accumulate attribute information that specifies an attribute of each worker, in addition to the worker ID. In this case, upon being instructed to classify the workers into groups based on the attribute information, the rule creation unit 12 creates rules for each group. In other words, the rule creation unit 12 extracts, from the task data, the task names, the task execution results, and the task reasons for each group, and furthermore, the rule creation unit 12 executes statistical processing.

In the present embodiment, the worker can input “the ultimate aim of the task” (hereinafter denoted as the “ultimate aim”) and “a sub-aim that should be achieved before the ultimate aim is reached” (hereinafter denoted as the “sub-aim”), using the terminal 20. In this case, the terminal 20 transmits the ultimate aim and the sub-aim to the skill transfer facilitating apparatus 10. In the skill transfer facilitating apparatus 10, the data receiving unit 13 receives these pieces of data, and outputs the received data to the rule creation unit 12.

Also the rule creation unit 12 specifies rules that correspond to the input ultimate aim and sub-aim, and associates the specified rules and the corresponding ultimate aim and sub-aim to build a database for skill transfer in the rule accumulation unit 14. The rule transmitting unit 15 extracts, from the database, the ultimate aim, sub-aim, and rules that best match the aid that a user has requested, and transmits them to the user's terminal 30.

### Operations of Apparatus

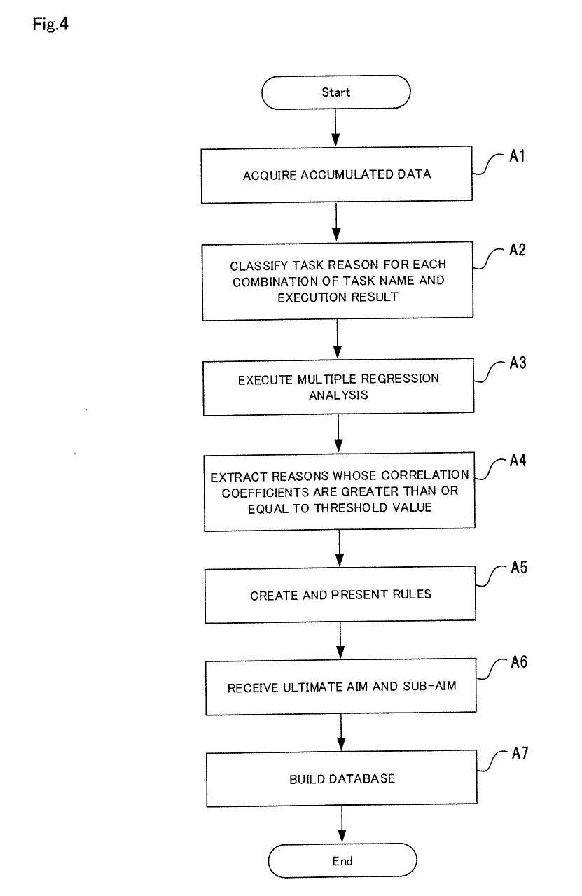

Next, the operations of the skill transfer facilitating apparatus according to the present embodiment will be described with reference to FIG. 4. FIG. 4 is a flowchart showing the operations of a skill transfer facilitating apparatus according to the present embodiment. In the following description, FIG. 1 is referred to as appropriate. In the present embodiment, the skill transfer facilitating method is carried out by operating the skill transfer facilitating apparatus 10. Therefore, the following description of the operations of the skill transfer facilitating apparatus 10 substitutes for a description of the method for facilitating the skill transfer according to the present embodiment.

First, as a premise, it is assumed in the present embodiment that task data regarding the growing of oranges has been transmitted from a large number of workers. In the skill transfer facilitating apparatus 10, the data receiving unit 13 has received the task data thus transmitted, and has accumulated the received task data in the data accumulation unit 11. In such a situation, the following steps, which are shown in FIG. 4, are executed.

As shown in FIG. 4, first, the rule creation unit 12 acquires, from the data accumulation unit 11, task data (see FIG. 3) that is accumulated therein (step A1). Next, the rule creation unit 12 extracts all of the combinations of a task name and an execution result from the task data acquired in step A1, and classifies the task reasons for each of the extracted combinations (step A2).

Next, for each of the combinations extracted in step A2, the rule creation unit 12 executes multiple regression analysis with respect to each of the corresponding task reasons, and thus calculates a correlation coefficient of each of the corresponding task reasons (step A3).

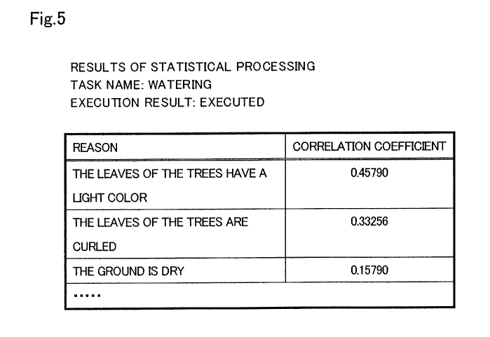

Here, step A3 will be specifically described with reference to FIG. 5. FIG. 5 is a diagram showing an example of results of statistical processing according to the embodiment of the present invention. In the example shown in FIG. 5, multiple regression analysis is executed with respect to the combination of the task name “watering” and the execution result “executed”.

Specifically, for each combination of the task name “watering” and the execution result “executed”, the rule creation unit 12 extracts the corresponding task reasons. Then, assuming that the reasons are explanatory variables (X₁, X₂, . . . , and Xₙ) (see FIG. 3) and the execution result is a dependent variable Y, the rule creation unit 12 substitutes each combination of a reason and an execution result into Math. 1 below, to determine the correlation coefficients (b₀, b₁, b₂, . . . , and bₙ) so that an error between the dependent variable Y and an actual execution result YE is at its smallest. It is assumed that “an error between the dependent variable Y and an actual execution result YE is at its smallest” means that J shown in Math. 2 below is at its smallest. In the present embodiment, the correlation coefficients are calculated by using a least-squares method so that J will be the smallest. Note that n is a natural number. Although the equation expressed as Math. 1 is a linear equation (a first-degree function), a quadratic function or an exponential function may be used as well.

Y=b₀+b₁X₁+b₂X₂+ . . . +bₙXₙ [Math. 1]

J=Σ (YE+Y)² [Math. 2]

Next, the rule creation unit 13 extracts reasons whose correlation coefficients thus calculated are greater than or equal to a threshold value (step A4). Then, the rule creation unit 12 generates rules by using the extracted reasons, and accumulates the created rules in the rule accumulation unit 14. Also, in step A4, the rule creation unit 12 presents the created rules to the worker via the terminal 20 (step A5).

Specifically, if the threshold value of correlation coefficients is set to 0.15000, the rule creation unit 12 extracts “the leaves of the trees have a light color”, “the leaves of the trees are curled”, and “the ground is dry” with respect to the cases where watering was executed. Then, the rule creation unit 12 generates rules, using the extracted reasons. In the example shown in FIG. 5, the rule creation unit 12 creates the following rules: “water the trees if the leaves of the trees have a light color”; “water the trees if the leaves of the trees are curled”; and “water the trees if the ground is dry”.

Also, using two or more reasons whose correlation coefficients are high, the rule creation unit 12 can also create a rule that includes all of these reasons, e.g. “water the trees if the leaves of the trees have a light color and the leaves of the trees are curled”.

Furthermore, the rule creation unit 12 can also substitute a correlation coefficient that satisfies a set condition into Math. 1 above so that the equation thus obtained serves as a rule. For example, if b₀=0.1, b₁=0.2, and b₂=0.1 are satisfied, the rule creation unit 12 can also create “Y=0.1+0.2X₁+0.1X₂” as a rule. If Y is greater than or equal to 1, the rule serves as a rule that defines a case where a task should be executed, but if Y is smaller than 1, the rule serves as a rule that defines a case where a task should not be executed.

In other words, if the leaves of the trees have a light color (X₁=3) and the leaves of the trees are slightly curled (X₂=2), the rule “Y=0.1+0.2X₁+0.1X₂” is expressed as Y=0.1+0.2×3+0.1×3=1.0, which serves as a rule that defines a case where watering should be executed. On the other hand, if the leaves of the trees have a dark color (X₁=2) and the leaves of the trees are slightly curled (X₂=2), the rule “Y=0.1+0.2X₁+0.1X₂” is expressed as Y=0.1+0.2×2+0.1×3=0.8, which serves as a rule that defines a case where watering should not be executed.

Next, after rules has been presented to the worker in step A5, upon the worker transmitting the ultimate aim and the sub-aim via the terminal 20, the data receiving unit 13 in the skill transfer facilitating apparatus 10 receives the ultimate aim and the sub-aim, and inputs them to the rule creation unit 12 (step A6). Next, the rule creation unit 12 associates the input ultimate aim and sub-aim with the rules created in step A5 to build a database in the rule accumulation unit 14 (step A7).

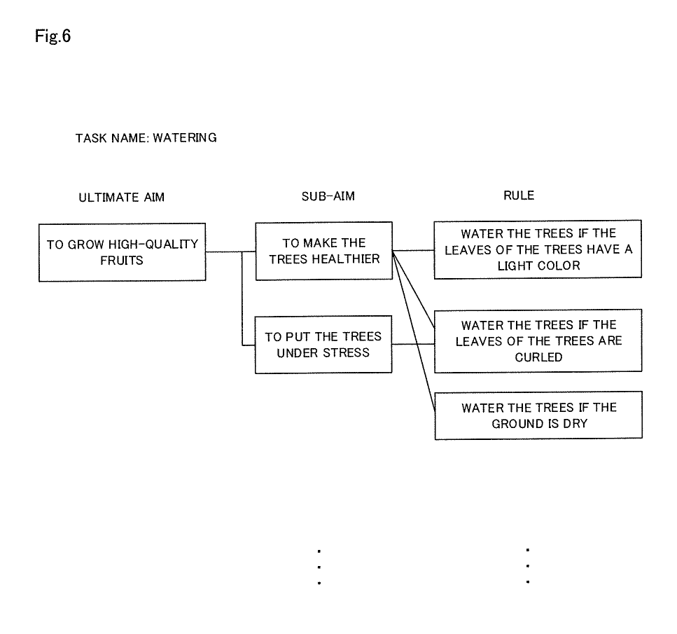

Here, the database that is built in step A7 will be described with reference to FIG. 6. FIG. 6 is a diagram showing an example of a database that is built in the embodiment of the present invention. In the example shown in FIG. 6, a tree structure is built, in which the ultimate aim is at the top and the created rules are child nodes at the bottom.

Here, it is assumed that a user has requested the aid of the skill transfer facilitating apparatus 10 via the terminal 30 after step A7 has been executed. In this case, in the skill transfer facilitating apparatus 10, the rule transmitting unit 15 extracts, from the database that has been built in the rule accumulation unit 14, the ultimate aim, sub-aim, and rules that best match the aid that the user requested, and transmits them to the user's terminal 30.

If the user has made an instruction to create rules for a particular user or a particular group of users, the rule creation unit 12 acquires only task data for the specified user or group in step A1. Then, using only the task data for the specified user or group, the rule creation unit 12 executes the subsequent steps A2 to A7. In this case, rules and a database are created for each user or each group of users.

### Effects of Embodiment

Inexperienced farmers, which are envisaged as users in the present embodiment, and experienced farmers, which are envisaged as operators who input task data in the present embodiment, may pay attention to different points due to the difference in experience.

For example, it is assumed that an experienced farmer has executed watering as a farming task under the condition that rainfall is low, and has input this fact as task data. In this case, if the task data input by the farmer is determined as a rule as is, a rule indicating that watering should be executed when rainfall is low is presented to the user.

However, in reality, experienced farmers determine whether or not to execute watering by checking not only the state of rainfall but also the color of the leaves of the trees. This is because a crop may be adversely affected if watering is executed only on the grounds that rainfall is low. Such a situation in which conditions other than the state of rainfall are not included in the rule occurs because it is only natural for experienced farmers to pay attention to the color of the leaves of the trees.

In contrast, in the present embodiment, task data from a plurality of workers is subjected to statistical processing. Therefore, even if there is a task reason that was not recorded by a worker because the reason was too obvious for the worker, it can be expected that the task reason has been recorded by other workers, and rules that include, without exception, all of the points to which experienced farmers pay attention are created. That is to say, according to the present embodiment, it is possible to create rules with a high degree of completion, and consequently, it is possible to execute appropriate skill transfer even if the user to which skills are to be transferred is inexperienced. Also, the user to which skills are transferred can efficiently acquire skills.

### Program

The program in the embodiment of the present embodiment can be any program that causes a computer to execute the steps A1 to A7 shown in FIG. 4. It is possible to realize the skill transfer facilitating apparatus and the skill transfer facilitating method according to the present embodiment by installing the program onto a computer and executing the program. In this case, a CPU (Central Processing Unit) of the computer functions as the rule creation unit 12, and executes processing.

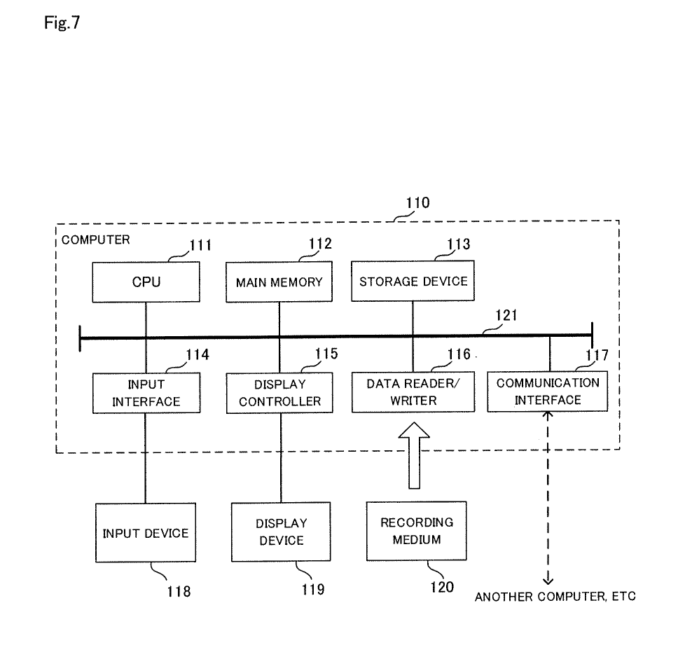

Here, a computer that executes a program according to the present embodiment to realize the skill transfer facilitating apparatus will be described with reference to FIG. 7. FIG. 7 is a block diagram showing an example of a computer that realizes the skill transfer facilitating apparatus according to the embodiment of the present invention.

As shown in FIG. 7, a computer 110 includes a CPU 111, a main memory 112, a storage device 113, an input interface 114, a display controller 115, a data reader/writer 116, and a communication interface 117. These units are connected to each other via a bus 121 so as to be able to perform data communication.

The CPU 111 loads a program (codes) according to the present embodiment, which are stored in the storage device 113, to the main memory 112, and executes various kinds of computation by executing them in a predetermined order. The main memory 112 is, typically, a volatile storage device such as a DRAM (Dynamic Random Access Memory). The program according to the present embodiment is provided in the state of being stored in a computer-readable recording medium 120. Note that the program according to the present embodiment may be distributed via the Internet to which the computer is connected via the communication interface 117.

Specific examples of the storage device 113 include, in addition to a hard disk drive, a semiconductor storage device such as a flash memory. The input interface 114 mediates data transmission between the CPU 111 and an input device 118 such as a keyboard or a mouse. The display controller 115 is connected to a display device 119, and controls display on the display device 119.

The data reader/writer 116 mediates data transmission between the CPU 111 and the recording medium 120, and reads the program from the recording medium 120 and writes the results of processing executed by the computer 110 to the recording medium 120. The communication interface 117 mediates data transmission between the CPU 111 and another computer.

Specific examples of the recording medium 120 include multi-purpose semiconductor storage devices such as a CF (Compact Flash (registered trademark) and an SD (Secure Digital), magnetic storage media such as a flexible disk, and optical storage media such as a CD-ROM (Compact Disk Read Only Memory).

The above-described embodiment can be partially or entirely expressed by, but not limited to, the following Supplementary Notes 1 to 18.

### Supplementary Note 1

A skill transfer facilitating apparatus for facilitating skill transfer, comprising:

a data accumulation unit that accumulates data regarding tasks that are executed using skills that are to be transferred; and

a rule creation unit that extracts, from the data that is accumulated, task names, task execution results, and task reasons as information, executes, for each combination of a task name and a task execution result thus extracted, statistical processing with respect to each corresponding task reason, and then creates, for each task, a rule that serves as a condition for executing the task or a rule that serves as a condition for not executing the task, based on the result of statistical processing.

### Supplementary Note 2

The skill transfer facilitating apparatus according to Supplementary Note 1, wherein the rule creation unit executes, for each combination of a task name and a task execution result, multiple regression analysis as the statistical processing with respect to each corresponding task reason to calculate a correlation coefficient for each corresponding task reason, and creates the rule by using a task reason whose correlation coefficient is greater than or equal to a threshold value.

### Supplementary Note 3

The skill transfer facilitating apparatus according to Supplementary Note 1, wherein the data that is accumulated in the data accumulation unit includes worker information that identifies workers that have executed the tasks, and the rule creation unit extracts a task name, a task execution result, and a task reason from the data, for each worker, based on the worker information, and furthermore, executes the statistical processing to create a rule for each worker.

### Supplementary Note 4

The skill transfer facilitating apparatus according to Supplementary Note 1, wherein the data that is accumulated in the data accumulation unit includes worker information that identifies workers that have executed the tasks, and attribute information that specifies attributes of the workers that have executed the tasks, and

upon being instructed to classify the workers into groups based on the attribute information, the rule creation unit extracts task names, task execution results, and task reasons for each group from the data, and furthermore, executes the statistical processing to create a rule for each group.

### Supplementary Note 5

The skill transfer facilitating apparatus according to Supplementary Note 1,

wherein upon a worker who has executed a task inputting an ultimate aim of the task and a sub-aim that should be achieved before the ultimate aim is reached, the rule creation unit specifies a rule that corresponds to the ultimate aim and the sub-aim, and associates the rule thus specified with the ultimate aim and the sub-aim that correspond thereto, to build a database.

### Supplementary Note 6

The skill transfer facilitating apparatus according to Supplementary Note 1,

wherein, when the data that is accumulated in the data accumulation unit includes an image that relates to a task, the rule creation unit adds the corresponding image to the rule that has been created.

### Supplementary Note 7

A skill transfer facilitating method for facilitating skill transfer, comprising:

(a) a step of accumulating data regarding tasks that are executed using skills that are to be transferred; and

(b) a step of extracting, from the data that is accumulated, task names, task execution results, and task reasons as information, executing, for each combination of a task name and a task execution result thus extracted, statistical processing with respect to each corresponding task reason, and then creating, for each task, a rule that serves as a condition for executing the task or a condition for not executing the task, based on the result of statistical processing.

### Supplementary Note 8

The skill transfer facilitating method according to Supplementary Note 7,

wherein, in the step (b), for each combination of a task name and a task execution result, multiple regression analysis is executed as the statistical processing with respect to each corresponding task reason, to calculate a correlation coefficient for each corresponding task reason, and the rule is created by using a task reason whose correlation coefficient is greater than or equal to a threshold value.

### Supplementary Note 9

The skill transfer facilitating method according to Supplementary Note 7,

wherein, in the step (b), when the data that is accumulated includes worker information that identifies workers that have executed the tasks, a task name, a task execution result, and a task reason are extracted from the data, for each worker, based on the worker information, and furthermore, the statistical processing is executed to create a rule for each worker.

### Supplementary Note 10

The skill transfer facilitating method according to Supplementary Note 7,

wherein, in the step (b), when the data that is accumulated includes worker information that identifies workers that have executed the tasks, and attribute information that specifies attributes of the workers that have executed the tasks, and an instruction to classify the workers into groups based on the attribute information has been made, task names, task execution results, and task reasons are extracted from the data, for each group, and furthermore, the statistical processing is executed to create a rule for each group.

### Supplementary Note 11

The skill transfer facilitating method according to Supplementary Note 7,

(d) a step of, upon a worker who has executed a task inputting an ultimate aim of the task and a sub-aim that should be achieved before the ultimate aim is reached, specifying a rule that corresponds to the ultimate aim and the sub-aim and associating the rule thus specified with the ultimate aim and the sub-aim that correspond thereto, to build a database.

### Supplementary Note 12

The skill transfer facilitating method according to Supplementary Note 7,

wherein, when the data that is accumulated in the step (a) includes an image that relates to a task, the corresponding image is added, in the step (b), to the rule that has been created.

### Supplementary Note 13

A computer-readable recording medium on which a program for facilitating skill transfer using a computer is recorded, the program including an instruction to cause the computer to execute:

(a) a step of accumulating data regarding tasks that are executed using skills that are to be transferred; and

(b) a step of extracting, from the data that is accumulated, task names, task execution results, and task reasons as information, executing, for each combination of a task name and a task execution result thus extracted, statistical processing with respect to each corresponding task reason, and then creating, for each task, a rule that serves as a condition for executing the task or a rule that serves as a condition for not executing the task, based on the result of statistical processing.

### Supplementary Note 14

The computer-readable recording medium according to Supplementary Note 13,

wherein, in the step (b), for each combination of a task name and a task execution result, multiple regression analysis is executed as the statistical processing with respect to each corresponding task reason, to calculate a correlation coefficient for each corresponding task reason, and the rule is created by using a task reason whose correlation coefficient is greater than or equal to a threshold value.

### Supplementary Note 15

The computer-readable recording medium according to Supplementary Note 13,

wherein, in the step (b), when the data that is accumulated includes worker information that identifies workers that have executed the tasks, a task name, a task execution result, and a task reason are extracted from the data, for each worker, based on the worker information, and furthermore, the statistical processing is executed to create a rule for each worker.

### Supplementary Note 16

The computer-readable recording medium according to Supplementary Note 13,

wherein, in the step (b), when the data that is accumulated includes worker information that identifies workers that have executed the tasks, and attribute information that specifies attributes of the workers that have executed the tasks, and an instruction to classify the workers into groups based on the attribute information has been made, task names, task execution results, and task reasons are extracted from the data, for each group, and furthermore, the statistical processing is executed to create a rule for each group.

### Supplementary Note 17

The computer-readable recording medium according to Supplementary Note 13,

wherein the program further includes an instruction to cause the computer to execute:

(d) a step of, upon a worker who has executed a task inputting an ultimate aim of the task and a sub-aim that should be achieved before the ultimate aim is reached, specifying a rule that corresponds to the ultimate aim and the sub-aim and associating the rule thus specified with the ultimate aim and the sub-aim that correspond thereto, to build a database.

### Supplementary Note 18

The computer-readable recording medium according to Supplementary Note 13,

wherein, when the data that is accumulated in the step (a) includes an image that relates to a task, the corresponding image is added, in the step (b), to the rule that has been created.

Although the present invention has been described with reference to an embodiment, the present invention is not limited to the above-described embodiment. Various modifications that a person skilled in the art can understand may be applied to the configuration and the details of the present invention within the scope of the present invention.

This application claims priority to Japanese Patent Application No. 2015-014259, filed on Jan. 28, 2015, the disclosure of which is incorporated in its entirety herein by reference.

### INDUSTRIAL APPLICABILITY

As described above, the present invention can improve the degree of completion of rules that are used in skill transfer. The present invention is useful in the fields of industry in which skill transfer is required, such as the fields of agriculture, traditional craftwork, fisheries, forestry, and nursing care.

### DESCRIPTION OF REFERENCE NUMERALS

10: Skill Transfer Facilitating Apparatus

11: Data Accumulation Unit

12: Rule Creation Unit

13: Data Receiving Unit

14: Rule Accumulation Unit

15: Rule Transmitting Unit

20: Worker's Terminal

30: User's Terminal

110: Computer

111: CPU

112: Main Memory

113: Storage Device

114: Input Interface

115: Display Controller

116: Data Reader/Writer

117: Communication Interface

118: Input Device

119: Display Device

120: Recording Medium

121: Bus

1. A skill transfer facilitating apparatus for facilitating skill transfer, comprising:
a data accumulation unit that accumulates data regarding tasks that are executed using skills that are to be transferred; and
a rule creation unit that extracts, from the data that is accumulated, task names, task execution results, and task reasons as information, executes, for each combination of a task name and a task execution result thus extracted, statistical processing with respect to each corresponding task reason, and then creates, for each task, a rule that serves as a condition for executing the task or a condition for not executing the task, based on the result of statistical processing.

2. The skill transfer facilitating apparatus according to claim 1,
wherein the rule creation unit executes, for each combination of a task name and a task execution result, multiple regression analysis as the statistical processing with respect to each corresponding task reason, to calculate a correlation coefficient for each corresponding task reason, and creates the rule by using a task reason whose correlation coefficient is greater than or equal to a threshold value.

3. The skill transfer facilitating apparatus according to claim 1,
wherein the data that is accumulated in the data accumulation unit includes worker information that identifies workers that have executed the tasks, and
the rule creation unit extracts a task name, a task execution result, and a task reason from the data, for each worker, based on the worker information, and furthermore, executes the statistical processing to create a rule for each worker.

4. The skill transfer facilitating apparatus according to claim 1,
wherein the data that is accumulated in the data accumulation unit includes worker information that identifies workers that have executed the tasks, and attribute information that specifies attributes of the workers that have executed the tasks, and
upon being instructed to classify the workers into groups based on the attribute information, the rule creation unit extracts task names, task execution results, and task reasons from the data, for each group, and furthermore, executes the statistical processing to create a rule for each group.

5. The skill transfer facilitating apparatus according to claim 1,
wherein upon a worker who has executed a task inputting an ultimate aim of the task and a sub-aim that should be achieved before the ultimate aim is reached, the rule creation unit specifies a rule that corresponds to the ultimate aim and the sub-aim, and associates the rule thus specified with the ultimate aim and the sub-aim that correspond thereto, to build a database.

6. The skill transfer facilitating apparatus according to claim 1,
wherein, when the data that is accumulated in the data accumulation unit includes an image that relates to a task, the rule creation unit adds the corresponding image to the rule that has been created.

7. A skill transfer facilitating method for facilitating skill transfer, comprising:
(a) a step of accumulating data regarding tasks that are executed using skills that are to be transferred; and
(b) a step of extracting, from the data that is accumulated, task names, task execution results, and task reasons as information, executing, for each combination of a task name and a task execution result thus extracted, statistical processing with respect to each corresponding task reason, and then creating, for each task, a rule that serves as a condition for executing the task or a condition for not executing the task, based on the result of statistical processing.

8. The skill transfer facilitating method according to claim 7,
wherein, in the step (b), for each combination of a task name and a task execution result, multiple regression analysis is executed as the statistical processing with respect to each corresponding task reason, to calculate a correlation coefficient for each corresponding task reason, and the rule is created by using a task reason whose correlation coefficient is greater than or equal to a threshold value.

9. The skill transfer facilitating method according to claim 7,
wherein, in the step (b), when the data that is accumulated includes worker information that identifies workers that have executed the tasks, a task name, a task execution result, and a task reason are extracted from the data, for each worker, based on the worker information, and furthermore, the statistical processing is executed to create a rule for each worker.

10. The skill transfer facilitating method according to claim 7,
wherein, in the step (b), when the data that is accumulated includes worker information that identifies workers that have executed the tasks, and attribute information that specifies attributes of the workers that have executed the tasks, and an instruction to classify the workers into groups based on the attribute information has been made, task names, task execution results, and task reasons are extracted from the data, for each group, and furthermore, the statistical processing is executed to create a rule for each group.

11. The skill transfer facilitating method according to claim 7, further comprising:
(d) a step of, upon a worker who has executed a task inputting an ultimate aim of the task and a sub-aim that should be achieved before the ultimate aim is reached, specifying a rule that corresponds to the ultimate aim and the sub-aim and associating the rule thus specified with the ultimate aim and the sub-aim that correspond thereto, to build a database.

12. The skill transfer facilitating method according to claims 7,
wherein, when the data that is accumulated in the step (a) includes an image that relates to a task, the corresponding image is added, in the step (b), to the rule that has been created.

13. A non transitory computer-readable recording medium on which a program for facilitating skill transfer using a computer is recorded, the program including an instruction to cause the computer to execute:
(a) a step of accumulating data regarding tasks that are executed using skills that are to be transferred; and
(b) a step of extracting, from the data that is accumulated, task names, task execution results, and task reasons as information, executing, for each combination of a task name and a task execution result thus extracted, statistical processing with respect to each corresponding task reason, and then creating, for each task, a rule that serves as a condition for executing the task or a condition for not executing the task, based on the result of statistical processing.

14. The non transitory computer-readable recording medium according to claim 13,
wherein, in the step (b), for each combination of a task name and a task execution result, multiple regression analysis is executed as the statistical processing with respect to each corresponding task reason, to calculate a correlation coefficient for each corresponding task reason, and the rule is created by using a task reason whose correlation coefficient is greater than or equal to a threshold value.

15. The non transitory computer-readable recording medium according to claim 13,
wherein, in the step (b), when the data that is accumulated includes worker information that identifies workers that have executed the tasks, a task name, a task execution result, and a task reason are extracted from the data, for each worker, based on the worker information, and furthermore, the statistical processing is executed to create a rule for each worker.

16. The non transitory computer-readable recording medium according to claim 13,
wherein, in the step (b), when the data that is accumulated includes worker information that identifies workers that have executed the tasks, and attribute information that specifies attributes of the workers that have executed the tasks, and an instruction to classify the workers into groups based on the attribute information has been made, task names, task execution results, and task reasons are extracted from the data, for each group, and furthermore, the statistical processing is executed to create a rule for each group.

17. The non transitory computer-readable recording medium according to claim 13,
wherein the program further includes an instruction to cause the computer to execute:
(d) a step of, upon a worker who has executed a task inputting an ultimate aim of the task and a sub-aim that should be achieved before the ultimate aim is reached, specifying a rule that corresponds to the ultimate aim and the sub-aim and associating the rule thus specified with the ultimate aim and the sub-aim that correspond thereto, to build a database.

18. The non transitory computer-readable recording medium according to claim 13,
wherein, when the data that is accumulated in the step (a) includes an image that relates to a task, the corresponding image is added, in the step (b), to the rule that has been created.
